(19) United States
(12) Patent Application Publication
(10) Pub. No.: US 2009/0014228 A1
(43) Pub. Date: Jan. 15, 2009

(54) Collision detector

(75) Inventors: Masanori Kawaura, Nukata-gun (JP); Norio Sanma, Okazaki-city (JP); Yuuji Kakuya, Okazaki-city (JP); Kyojiro Suzuki, Nagoya-city (JP); Toshihito Nonaka, Chiryu-city (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-city (JP)

(21) Appl. No.: 12/070,563

(22) Filed: Feb. 20, 2008

(30) Foreign Application Priority Data
Feb. 23, 2007 (JP) 2007-044487

(51) Int. Cl. B60R 21/00; H01H 35/00

(52) U.S. Cl. 180/274; 340/436

(57) ABSTRACT

A collision detector includes a deformable portion and a planar sensor accompanied by a process circuit and a collision determination unit. The deformable portion is configured to be deformed on a collision on an object. The planar sensor has a planar coil formed as a planar winding of winding wire to be deformed along the deformation of the deformable portion. The process circuit generates an electric signal that is in proportion to a self inductance Ls of the planar coil. The collision determination unit determines whether the object collided with the deformable member based on the change of the electric signal.

### CROSS REFERENCE TO RELATED APPLICATION

The present application is based on and claims the benefit of priority of Japanese Patent Application No. 2007-44487 filed on Feb. 23, 2007, the disclosure of which is incorporated herein by reference.

### FIELD OF THE INVENTION

The present disclosure generally relates to a collision detector for detecting collision of an object on a vehicle.

### BACKGROUND INFORMATION

Conventionally, a collision detector has a structure as disclosed in, for example, Japanese patent document JP-A-H07-186878. The detector in the above document has two single foot beams and plural side collision sensors. The two single foot beams respectively disposed at a position between an outer and inner panel of a vehicle door with its foot fixed on the inner panel in parallel with each other aligned to a front-rear direction of the vehicle. The side collision sensors are sensors that are configured to be turned on when pressured is applied thereon, and are disposed on the outer panel that faces the single foot beam with a predetermined amount of gap in the vehicle door. When the vehicle door collides with an object, the outer panel is dented toward the inner panel to apply pressure to the side collision sensor that is disposed on the single foot beam. Thus, the detector detects the collision of the object on the vehicle.

However, the conventional collision detector is large in volume due to a complicated structure such as the two single foot beams and the like, thereby making it difficult to be fit into a predetermined space. Especially, the inside space of the vehicle door has limited capacity due to various other devices such as speakers, power window mechanisms and the like. In other words, it is very important to preserve the inside space of the vehicle door.

### SUMMARY OF THE INVENTION

In view of the above and other problems, the present disclosure provides a collision detector that utilizes an inside space of a vehicle door in a space efficient manner.

The collision detector of the present invention includes a deformable member capable of being deformed on collision; a planar sensor having a coil in a planar shape to be bent by deformation of the deformable member, wherein the coil in the planar shape is formed with its winding wound in a plane; a process circuit capable of generating an electric signal in proportion to a self inductance of the coil in the planar shape; and a collision determination unit capable of determining the collision of the deformable member based on change in the electric signal.

The planar coil the sensor is configured to be deformable to change its shape into a bent form as the deformable member deforms. Further, the deformable member is made of material that deforms when it collides with an object. That is, the deformed condition of the planar coil is brought up when the deformable member collides with the object. Further, the planar coil changes its self inductance when bent by the deformation. More practically, the planar coil in a bent form has a smaller self inductance value in comparison to the coil in a non-bent form. Therefore, by sampling the change of its self inductance, the planar coil is used for detecting a collision of the deformable member. That is, the collision determination unit can determine whether the deformable member has collided with the object based on the change of an electric signal in proportion to the self inductance.

The collision detector of the present invention detects the collision of the deformable member by the above-described collision detection scheme. Further, the planar coil is preferably arranged to be susceptible to deformation along the deformation of the deformable member for detecting the collision. That is, the two single foot beams in the conventional collision detector or other complicated device is not required for detecting the collision. Therefore, the collision detector of the present invention can achieve an improved space utility. Further, the planar sensor has a planar shape, thereby providing the sensor ease of installation on the vehicle.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a vehicle side collision detection apparatus in a first embodiment of the present invention;

FIG. 2 shows a cross section of a vehicle door 10 in a vehicle right and left direction.

FIG. 3 shows an illustration of an outer panel 11 of the vehicle door 10 seen from a compartment side of a vehicle.

FIGS. 4A and 4B respectively show a cross section of the outer panel by a horizontal plane before and after a collision of an object with the outer panel;

FIG. 5 shows a diagram showing relations between a rate of change of a self-inductance of the planar coil and an amount of deformation D of the planar coil;

FIG. 6 shows a diagram showing a frequency characteristic of an LC resonance circuit;

FIG. 7 shows a cross section of the vehicle door 10 in another embodiment;

FIG. 8 shows a cross section of the vehicle door 10 in yet another embodiment.

### DETAILED DESCRIPTION

In the following description, a collision detector of the present invention is exemplarily shown as an application to a vehicular side collision detection apparatus which detects a collision of an object on a side of a vehicle.

### First Embodiment

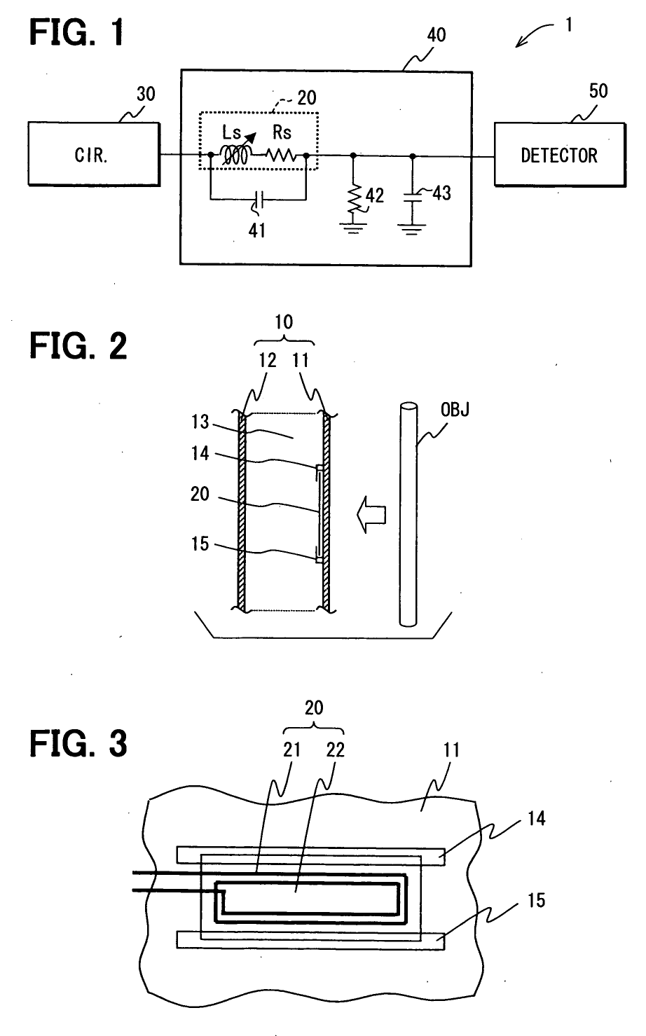

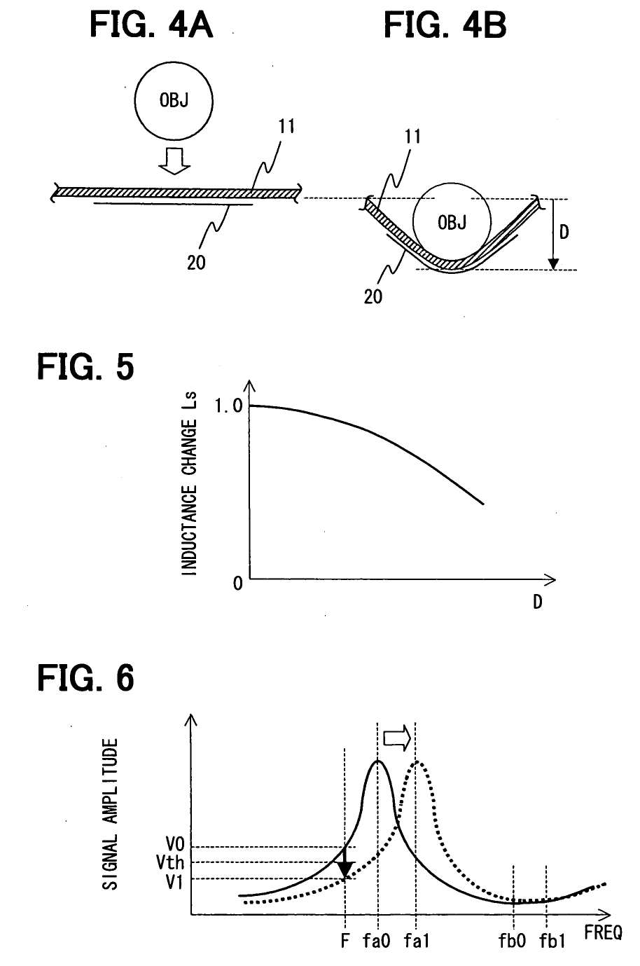

A configuration of the vehicular side collision detection apparatus 1 in the first embodiment of the present invention is explained with reference to FIGS. 1 to 5. In the present embodiment, the colliding object that collides with the side of the vehicle is assumed to be in a pillar shape such as a utility pole or the like. The colliding object is simply designated as an “object” in the following description. FIG. 1 is a block diagram of the collision detector 1 in the first embodiment. FIG. 2 is a cross-sectional view of a vehicle door 10. The cross section of the door 10 cuts the door 10 in a lateral direction, that is, in vehicle's right-left direction. FIG. 3 is an illustration of an outer panel 11 of the vehicle door 10 seen from an inside of a vehicle compartment. FIGS. 4A and 4B are cross-sectional views of the outer panel 11 in a horizontal cross section, and they illustrate conditions of the outer panel 11 before and after a collision with the object. More practically, FIG. 4A is an illustration showing a condition before the collision of the object with outer panel 11, and FIG. 4B is an illustration showing a condition after the collision of the object with panel 11. FIG. 5 is a diagram showing relations between a bending deformation D of a planar coil 21 and a change ratio of a self-inductance of the planar coil 21.

The collision detector 1 includes, as shown in FIG. 1, the outer panel 11 that serves as a deformable member, a planar sensor 20, an oscillation circuit 30, an LC resonance circuit 40, and a collision determination unit 50.

The outer panel 11 is a metal plate located on an outside of the vehicle in the vehicle door 10 that constitutes a vehicle body. In other words, the outer panel 11 of the vehicle door 10 bends towards the compartment of the vehicle when the object collided on the side of the vehicle. Further, the vehicle door 10 consists of an inner panel 12 which is a metal plate located on a compartment side of the door 10 and the outer panel 11 in the case. Furthermore, between the outer panel 11 and the inner panel 12, an indoor space 13 in the door is formed.

The planar sensor 20 consists of the planar coil 21 and a pair of films 22 as shown in FIGS. 2 to 4. The planar coil 21 is, for example, formed by a pattern printing of winding in a plane (in a coil shape) of conductive materials such as copper or the like. Further, a pair of films 22 binds the planar coil 21 from both sides so that the planar coil 21 does not exposed. The film 22 is, for example, formed in the shape of a film by using flexible materials such as PET (polyethylene terephthalate), PEN (polyethylene naphthalate) or the like. In other words, the film 22 is freely deformable. In addition, the planar coil 21 itself is also deformable to be bent in shapes.

The planar sensor 20 is arranged on the compartment side (a board 12 side) of the outer panel 11. More practically, the planar sensor 20 is disposed at a position between a pair of support members 14, 15 that are glued on a compartment side surface of the outer panel 11 and the compartment side surface of the outer panel 11, and the sensor 20 is bound by each of the pair of the support members 14, 15 and the compartment side surface in a non-adhesive manner. Further, the planar sensor 20 is arranged to have contact with the outer panel 11. Therefore, the planar sensor 20 bends along with the deformation of the outer panel 11 as shown in FIGS. 4A and 4B when the outer panel 11 is bent by the collision of the object. In addition, the bend of the planar sensor 20 invariably causes the bend of the planar coil 21.

A self-inductance Ls of the planar coil 21 changes in accordance with the bend of the planar coil 21. The following situation is used for an explanation of the inductance change referring to FIGS. 4 and 5. That is, in the situation, the outer panel 11 bends as shown in FIGS. 4A and 4B when the object collided on the outer panel 11. In this case, the bend of the outer panel 11 caused by the collision of the object is measured an amount of warpage of the outer panel 11 that is designated as deformation D. The amount of the deformation D corresponds to the amount of deformation of the planar coil 21. As shown in FIG. 5, the rate of change of the self-inductance Ls of the planar coil 21 decreases as the amount of deformation D increases. In other words, the self-inductance Ls takes the maximum value when the planar coil 21 is not in a deformed condition.

The oscillation circuit 30 (as conceptually claimed “a process circuit” in the present invention) generates an alternating current voltage (VAC) in an oscillating manner. The oscillatory frequency of the VAC is designated as Fa. The oscillatory frequency Fa is set to a frequency that is lower than a series resonance frequency fa0 of the planar coil 21 when the planar coil 21 mentioned later is not bent.

The LC resonance circuit 40 (as conceptually claimed as “a process circuit” in the present invention together with the oscillation circuit 30) constitutes a so-called serial-parallel LC resonance circuit. More practically, the LC resonance circuit 40 consists of the planar coil 21, a first capacitor 41, a second resistor 42, and a second capacitor 43. The planar coil 21 has its one end connected to the oscillation circuit 30, and has its another end connected to the collision determination unit. The first capacitor 41 is connected in parallel with the planar coil 21. The second resistor 42 has its one end connected to the another end of the planar coil 21, and has its another end connected to the ground. The second capacitor 43 has its one end connected to the another end of the planar 21, and has its another end connected to the ground.

The planar coil 21 can be considered as an equivalent of a series circuit having the self-inductance Ls and the ohmic value Rs. The self-inductance Ls is a variable as shown in FIG. 5. In addition, capacitance of the first capacitor 41 is designated as Cs, and the ohmic value of the second resistor 42 is designated as Ro, and capacitance of the second capacitor 43 is designated as Co.

Frequency characteristics of the LC resonance circuit 40 is explained with reference to FIG. 6. In the diagram in FIG. 6, the solid line shows a frequency characteristic of the LC resonance circuit 40 in a condition that the planar coil 21 is not deformed, and the dashed line shows a frequency characteristic of the LC resonance circuit 40 in a condition that the planar coil 21 is deformed.

In terms of the frequency characteristic of the LC resonance circuit 40, the amplitude reaches its maximum at the series resonance frequency fa (fa0, fa1) as shown in FIG. 6, and decreases to its minimum at the parallel resonance frequency fb (fb0, fb1). The series resonance frequency fa and the parallel resonance frequency fb are determined by the self-inductance Ls of the planar coil 21 and the capacity Cs, Co of the capacitor, and are represented by equations 1 and 2.

$$\begin{matrix}fa = \frac{1}{2 π \sqrt{Ls \cdot ( Cs + Co )}} & [ Equation 1 ] \\ fb = \frac{1}{2 π \sqrt{Ls \cdot Cs}} & [ Equation 2 ]\end{matrix}$$

The self-inductance Ls decreases, as stated above, when the planar coil 21 is bent. Then, the series resonance frequency fa1 in a case that the planar coil 21 is bent increases in comparison with the series resonance frequency fa0 in a case that the planar coil 21 is not bent. In addition, the parallel resonance frequency fb1 in a case that the planar coil 21 is bent increases in comparison with the parallel resonance frequency fb0 in a case that the planar coil 21 is not bent. In other words, as shown in FIG. 6, the frequency characteristic when the planar coil 21 is bent as shown in the dashed line moves to the right side of the FIG. 6 as a whole relative to the frequency characteristic when the planar coil 21 is not bent as shown in the solid line.

Then, the LC resonance circuit 40 outputs the electrical signal of periodic nature based on the VAC applied by the oscillation circuit 30 for changing the amplitude according to the frequency characteristics of the LC resonance circuit. More practically, the electric signal of periodic nature output from the LC resonance circuit 40 is the signal of VCA from the oscillation circuit 30 with its amplitude converted to the frequency characteristics of the LC resonance circuit at the oscillatory frequency Fa that oscillates the oscillation circuit 30.

The oscillatory frequency Fa of the VAC that oscillates the oscillation circuit 30 is, as described above, set to a frequency that is lower than the series resonance frequency fa. In addition, the resonance frequencies fa, fb increase farther as the planar coil 21 is bent to a greater degree. In other words, the oscillatory frequency Fa is set outside of a frequency range that is defined as a variation range of the resonance frequencies fa, fb of the LC resonance circuit 40 due to the bent of the planar coil 21 along with the bent of the outer panel 11 that is collided with the object.

That is, the amplitude of the frequency characteristics of the LC resonance circuit 40 in the oscillatory frequency Fa reaches its maximum when the planar coil 21 is not bent. Further, the amplitude concerned decreases when the amount of of deformation D of the planar coil 21 increases. In this manner, the amplitude of the electrical signal of periodic nature from the LC resonance circuit 40 changes depending on the amount of deformation D of the planar coil 21. In other words, the amplitude of the electrical signal of the periodic nature from the LC resonance circuit 40 changes to a smaller amount when the amount of deformation D of the planar coil 2 increases. That is, the LC resonance circuit 40 generates the electrical signal of the periodic nature according to the self-inductance Ls of the planar coil 21 as its output.

The collision determination unit 50 memorizes a threshold amplitude Vth to determine whether an object has collided with the outer panel 11. The threshold amplitude Vth is set to a value that is smaller than the standard amplitude V0 of the electrical signal of periodic nature output from the LC resonance circuit 40 corresponding to a condition that the planar coil 21 is not bent. And, the collision determination unit 50 determines whether an object has collided with the outer panel 11 based on an amplitude V1 of the electrical signal of periodic nature output from the LC resonance circuit 40. More practically, the collision determination unit 50 determines whether the amplitude V1 of the electric signal of the periodic nature from the LC resonance circuit 40 is smaller than the threshold amplitude Vth. Then, it is determined that an object has collided with the outer panel 11 when the amplitude V1 is smaller than the threshold amplitude Vth.

A collision of an object with the outer panel 11 is detected surely in the above-described manner in the present embodiment. Further, because the sensor used in the present embodiment is the planar sensor 20, space efficiency is achieved, and installation is performed with ease. Furthermore, in the present embodiment, the bent of the planar sensor 20 happens approximately at the same time as the bent of the outer panel 11 due to the arrangement of the planar sensor 20 in contact with the outer panel 11. Therefore, responsiveness can be set to a preferable condition. Furthermore, by putting the planar sensor 20 in a non-adhesive condition to the outer panel, a deformation of the planar sensor 20 in an extending manner is prevented even when the outer panel 11 is deformed in an extending manner. In other words, disconnection of the planar coil 21 due to the deformation of the planar sensor 20 in the extending manner can be prevented.

### Other Embodiments

Although the present invention has been fully described in connection with the preferred embodiment thereof with reference to the accompanying drawings, it is to be noted that various changes and modifications will become apparent to those skilled in the art.

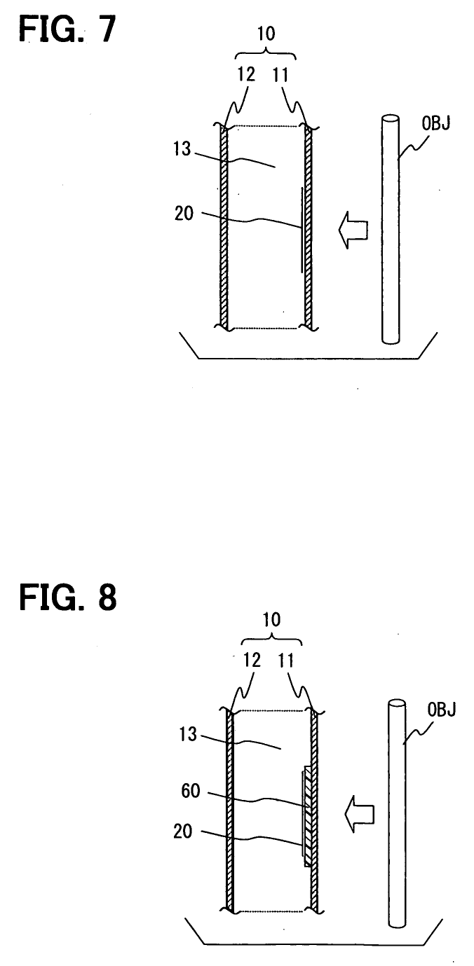

In the collision detection apparatus 1 of the first embodiment stated above, the planar sensor 20 is disposed between the outer panel 11 and a pair of the support members 14, 15. The planar sensor 20 is in contact with the outer panel 11 and the pair of the support members 14, 15 in a non-adhesive manner. Alternatively, the planar sensor 20 may be directly bonded to a surface of the compartment side of the outer panel 11. The above structure is illustrated in FIG. 7. The illustration in FIG. 7 is a cross section of the vehicle door 10 in a plane that horizontally cuts the vehicle body in a lateral (i.e., right-left) direction.

In this case, the pair of the support members 14, 15 is not required. In this structure, the planar sensor 20 is easily installed on the outer panel 11. However, the outer panel having a tearing (i.e., extending) force applied thereto in the course of being bent may cause the disconnection of the coil 21. Therefore, the outer panel 11 may be configured to resist to the extending force, or the coil 21 may be configured to be prevented from being disconnected in the course of being bent by the extending force.

Further, the planar sensor 20 may be detached from the outer panel 11 in a non-contacting manner instead of the contacting disposition. FIG. 8 shows a cross sectional illustration of the vehicle door 10 on a horizontal plane that cuts the vehicle body in the lateral direction.

The collision detection apparatus 1 may further include an installation attachment 60 as shown in FIG. 8. The installation attachment 60 may be a product made of resin, and is glued on the compartment side surface of the outer panel 11. The installation attachment 60 may be in a rectangular flat board shape. The planar sensor 20 is glues on a compartment side surface of the installation attachment 60 that is opposite to the outer panel facing side of the attachment 60. The planar coil 20 is, as described above, detached away from the outer panel 11 by the thickness of the installation attachment 60.

The change of the self-inductance Ls of the planar coil 21 in the course of deformation is greater when the planar coil 21 is disposed closer to a metal member. In other words, the change of the self-inductance Ls of the planar coil 21 is caused only by a small deformation of the planar coil 21. In this case, reference point (zero point) setting and/or determination threshold in the collision determination unit 50 may not be simple. Therefore, by detaching the planar sensor 20 away from the outer panel 11 that is made of the metallic material, the reference point and the like of the determination unit 50 may be easily set.

The detachment of the planar sensor 20 from the panel 11 may cause the deformation of the planar coil 20 to be less accurate relative to the deformation of the panel 11. In other words, the deformation of the planar coil 21 may be delayed from the deformation of the outer panel 11. However, the planar coil 21 can be securely and simultaneously deformed with the deformation of the outer panel 11 by installing the planar sensor 20 on the outer panel 11 by using the installation attachment 60 as described-above. Therefore, the response time can be prevented from getting longer.

Such changes and modifications are to be understood as being within the scope of the present invention as defined by the appended claims.

What is claimed is:

1. A collision detector comprising:
a deformable member capable of being deformed on collision;
a planar sensor having a coil in a planar shape to be bent by deformation of the deformable member, wherein the coil in the planar shape is formed with its winding wound in a plane;
a process circuit capable of generating an electric signal in proportion to a self inductance of the coil in the planar shape; and
a collision determination unit capable of determining the collision of the deformable member based on change in the electric signal.

2. The collision detector of claim 1, wherein
the planar deformation sensor is formed by binding the coil in the planar shape with a pair of freely-deformable films.

3. The collision detector of claim 1, wherein
the planar sensor is disposed in contact with the deformable member.

4. The collision detector of claim 3, wherein
the planar sensor is disposed in contact with the deformable member in a non-adhesion condition.

5. The collision detector of claim 3, wherein
the planar sensor is glued to the deformable member.

6. The collision detector of claim 1, wherein
the deformable member is made of metallic material, and
the planar sensor is disposed in a detached manner from the deformable member.

7. The collision detector of claim 6, wherein
the deformable member has an installation attachment made of non-metallic material, and
the planar sensor is attached to the installation attachment.

8. The collision detector of claim 1, wherein
the process circuit is an LC resonance circuit that includes an oscillator for generating an alternative voltage, a capacitor and the coil in the planar shape to output the electric signal of periodic nature in response to an application of the alternative current, and
the collision determination unit determines the collision of the deformable member based on an amplitude of the electric signal of periodic nature output from the LC resonance circuit.

9. The collision detector of claim 8, wherein
the alternative voltage generated by the resonance circuit has a resonance frequency set at an outside of a resonance frequency range of the LC resonance circuit that is caused by the deformation of the coil in the planar shape due to the deformation of the deformable member.

10. The collision detector of claim 9, wherein
the resonance frequency of the LC resonance circuit has plural resonance frequency, and
the resonance frequency of the alternative voltage generated by the resonance circuit is set to a frequency that is lower than a lowest frequency of the LC resonance circuit.

11. The collision detector of claim 1, wherein
the deformable member is an outer panel of a vehicle body,
the planar sensor is disposed on an inner side of the outer panel of the vehicle body, and
the collision determination unit determines whether the outer panel of the vehicle body has the collision.
